(19) United States
(12) Patent Application Publication
(10) Pub. No.: US 2017/0039450 A1
(43) Pub. Date: Feb. 9, 2017

(54) Identifying Entities to be Investigated Using Storefront Recognition

(71) Applicants: Shuchang ZHOU, Beijing (CN); Xin LI, San Jose, CA (US); Sheng LUO, Beijing (CN); Peng CHEN, Beijing (CN); Jian Li, Beijing (CN); Google Inc., Mountain View, CA (US)

(72) Inventors: Shuchang Zhou, Beijing (CN); Xin Li, San Jose, CA (US); Sheng Luo, Beijing (CN); Peng Chen, Beijing (CN); Jian Li, Beijing (CN)

(21) Appl. No.: 14/440,248

(22) PCT Filed: Apr. 30, 2014
(86) PCT No.: PCT/CN2014/076592

§ 371 Date: May 1, 2015

(51) Int. Cl. G06K 9/62; G06F 17/30; G06F 3/0484; H04N 5/232; G06K 9/46

(52) U.S. Cl. CPC G06K 9/6215; H04N 5/23293; G06K 9/623; G06K 9/4671; G06F 3/04842; G06F 17/30247; G06F 17/30277; G06F 17/30241; G06K 9/228

(57) ABSTRACT

Systems and methods for storefront recognition are provided. A surveyor or other user can access an application implemented on a computing device. A source image of a storefront of an entity can be captured by the surveyor using an image capture device (e.g. a digital camera). A feature matching process can be used to compare the source image against a plurality of candidate images of storefronts in the geographic area and return a list of the candidate images with the closest match. Each candidate image returned by the application can be annotated with a similarity score indicative of the similarity of the source image with the candidate image. The surveyor can use the similarity scores and the candidate images to determine whether the store has been previously investigated. The user can interact with the application to indicate whether the entity seeds to be investigated.

### FIELD

The present disclosure relates generally to data collection and more particularly to identifying an entity to be investigated for the collection of data using storefront recognition.

### BACKGROUND

Geographic information systems can provide for the archiving, retrieving, and manipulating of data that has been stored and indexed according to geographic coordinates of its elements. Geographic information systems can provide information associated with various businesses and entities in a geographic area, such as business names, addresses, store hours, menus, and other information. One method for collecting such information can be through the use of on-site surveyors. On-site (e.g. in persona at a business or other entity) surveyor scan collect information for various businesses and other entities in a geographic area by visiting the businesses or other entities and collecting the information. The use of on-site surveyors to collect information about businesses and other entities can lead to the increased detail and accuracy of business or entity information stored in the geographic information system.

### SUMMARY

Aspects and advantages of embodiments of the present disclosure will be set forth in part in the following description, or may be learned from the description, or may be learned through practice of the embodiment.

One example aspect of the present disclosure is directed to a computer-implemented method of identifying entities to be investigated in geographic areas. The method includes receiving, by one or more computing devices, a source image captured of a storefront of an entity in a geographic area. The source image is captured by an image capture device. The one or more computing devices include one or more processors. The method further includes accessing, by the one or more computing devices, a plurality of candidate images of storefronts in the geographic area and comparing, by the one or more computing devices, the source image against the plurality of candidate images to determine a similarity score for each of the plurality of candidate images. The method further includes selecting, by the one or more computing devices, a subset of the plurality of candidate images based at least in part on the similarity score for each of the plurality of candidate images and providing by the one or more computing devices, the subset of the plurality of candidate images for display on a display device. Each candidate image of the subset of the plurality of candidate images is provided for display in conjunction with the similarity score for the candidate image. The method further includes receiving, by the one or more computing devices, data indicative of a user selecting the entity to be investigated.

Other example aspects of the present disclosure are directed to systems, apparatus, tangible, non-transitory computer-readable media, user interfaces, memory devices, and electronic devices for identifying an entity to be surveyed in a geographic area.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a geographic area to be investigated using the systems and methods according to example embodiments of the present disclosure;

FIG. 2 depicts the example capturing of a source image for identifying an entity to be investigated according to example embodiments of the present disclosure;

FIGS. 3 and 4 depict example user interfaces for identifying an entity to be investigated according to example embodiments of the present disclosure;

FIG. 5 depicts a process flow diagram of an example method for identifying an entity to be investigated according to example embodiments of the present disclosure;

FIG. 6 depicts an example computer-based system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that assets of the present disclosure cover such modifications and variations.

### Overview

Generally, example aspects of the present disclosure are directed to systems and methods for identifying entities to be investigated in a geographic area. On-site (e.g. in persona at a store or business) surveyors can collect information (e.g. menus, business names, addresses, store hours, etc.) associated with businesses or other entities in a geographic area by visiting the entities and collecting information. As businesses and other entities open, close, and relocate, surveyors may need to periodically revisit the geographic area to update listings associated with a geographic area. When revisiting a geographic area the surveyor may need to determine whether a business or other entity has changed such that a new collection of data for the entity needs to be performed. In addition, the geographic information associated with a business or other entity (e.g. in a geographic information system) may no be sufficiently precise to be used to identity a particular business or entity at a particular location.

One indicator of whether a business or other entity has changed since the last investigation can be whether the storefront associated with a particular location has changed. As used herein, a storefront refers to at least a portion of an exterior and/or an interior of a building, location, or other premises that includes one or more features indicative of the business or other entity. For example, a storefront can be an exterior façade of a building or apace associated with an entity. A storefront can also be the budding in which the business or other entity is located or a signboard or other signage by the roadside. It can be difficult for surveyors to identity changed or updated storefronts because the surveyor may not have visited the geographic area prior to conducting the survey and/or because there are too many businesses located in the geographic area. As a result, surveyors may have to review all previous business listings associated with a geographic area to determine if a business has changed, which can be a tedious time-consuming and error-prone process.

According to example aspects of the present disclosure, computer-implemented systems and methods are provided to help recognize whether a business or other entity has previously been visited and investigated. More particularly, a surveyor or other user can access an application implemented on a computing device, such as a smartphone, tablet, wearable computing device, laptop, desktop, or other suitable computing device. One or more source images of a storefront of an entity can be captured by the surveyor using an image capture device (e.g. a digital camera). A feature matching process can be used to compare the one or more source images against a plurality of candidate images of storefronts in the geographic area and return a list of the candidate images with the closest match. Each candidate image returned by the application can be annotated with a similarity score indicative of the similarity of the source image with the candidate image. The surveyor can use the similarity scores and the returned candidate images to determine whether the store has been previously visited and investigated. The user can interact with the application to indicate whether the entity needs to be investigated.

As an example, a surveyor can access an application implemented on the surveyor's smartphone or other device. The surveyor can identify a geographic area to be surveyed, such as the name of a particular street to be surveyed. The application can obtain a plurality of candidate images (e.g. from a remote server over a network) of storefronts of businesses and other entities in the geographic area, such as entities that have been previously investigated. The plurality of candidate images can be a limited number of images, such as 100 images or less. When the surveyor arrives at the geographic area, the surveyor can capture one or more images of a storefront of a business or other entity in the geographic area using a digital camera (e.g. the digital camera integrated with the user's smartphone or other device). The image captured by the surveyor can be compared against the plurality of candidate images. The application can return a subset of the plurality of candidate images that are the closest match.

The application can display the source image and the subset of the plurality of candidate images in a user interface on a display device associated with the user's smartphone or other device. A similarity score can be displayed for each returned candidate image. The similarity score can be colored and/or sized based on the closeness of the match. For instance, the similarity score can be presented in green for a close match and can be presented in red otherwise. The surveyor can review the returned subset of images and the similarity scores to determine whether the business has previously been investigated. The user can then provide a user input to the application indicating whether whether the business needs to be investigated.

In example implementations of the present disclosure, the source image is compared against the plurality of candidate images using a feature matching process, such as a scale invariant feature transform (SIFT) feature matching process. To reduce false matches, the feature matching process can be implemented using geometric constraints, such as an epipolar constraint or a perspective constraint. With a limited number of candidate images in the plurality of candidate images (e.g. 100 images or less), the feature matching process with geometric constraints can be readily implemented on a local device, such as a smartphone or other user device, without requiring network connectivity for remote processing of data. In this way, the systems and methods according to example aspect of the present disclosure can provide a useful tool for surveyors in determining whether a business or other entity located in a remote area needs to be investigated.

Various embodiments discussed herein may access and analyze personal information about users, or make use of personal information, such as source images captured by a user and/or position information. In some embodiments, the user may be required to install an application or select a setting in order to obtain the benefits of the techniques described herein. In some embodiments, certain information or data can be treated in one or more ways before it is stored or used, so that personally identifiable information is removed. For example, a user's identity may be treated so that no personally identifiable information can be determined for the user.

### Example Storefront Recognition Applications

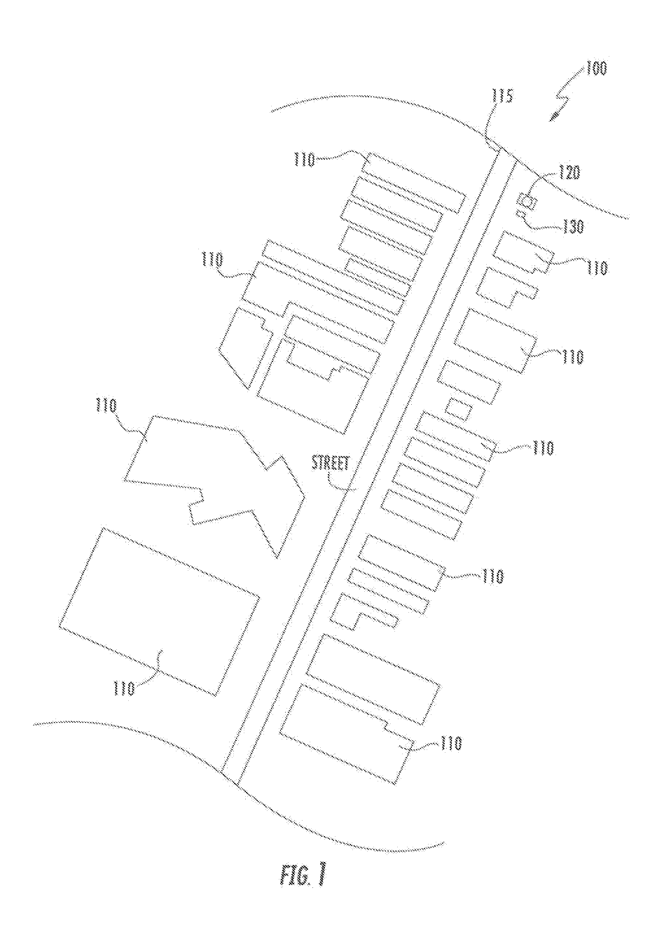

With reference now to the FIGS., example aspects of the present disclosure will be discussed in more detail. FIG. 1 depicts an example geographic area 100 that includes a plurality of businesses 110 located on a street 115. Geographic information systems (e.g. a mapping application, a virtual globe application, etc.) can index and store data associated with each of the plurality of businesses 110 in the geographic area 100. For instance, a geographic information system can include data indicative of addresses, business names, store hours, menus, etc. A user of the geographic information system can be presented with such information, for instance, when viewing imagery of the geographic area 100 (e.g. map imagery, aerial imagery, satellite imagery, three-dimensional models, etc.) in a user interface (e.g. a browser) associated with the geographic information system.

Information associated with the businesses 110 can be collected for use in the geographic information system at least in part using, for instance, on-site surveyors. For example, an on-site surveyor 120 can personally travel to the geographic area 100 and visit the plurality of businesses 110 to perform an investigation and collect information associated with the plurality of businesses 110. The on-site surveyor 120 can carry a user device 130, such as a smartphone, tablet, mobile devices, wearable computing device, or other suitable computing device. The on-site surveyor 120 can enter information into the user device 130, such as information associated with the plurality of businesses 110. The collected information can then be provided to the geographic information system.

During an investigation of the geographic area 100, the surveyor 120 may need to determine whether to investigate a particular business 110 located in the geographic area 100. For instance, if a business has changed or relocated since a previous investigation of the geographic area 100, the surveyor 120 may need to conduct an investigation of the new business 110. According to example aspects of the present disclosure, the surveyor 120 can access a storefront recognition application implemented on the user device 130 to determine whether a business 110 in the geographic area 100 needs to be investigated.

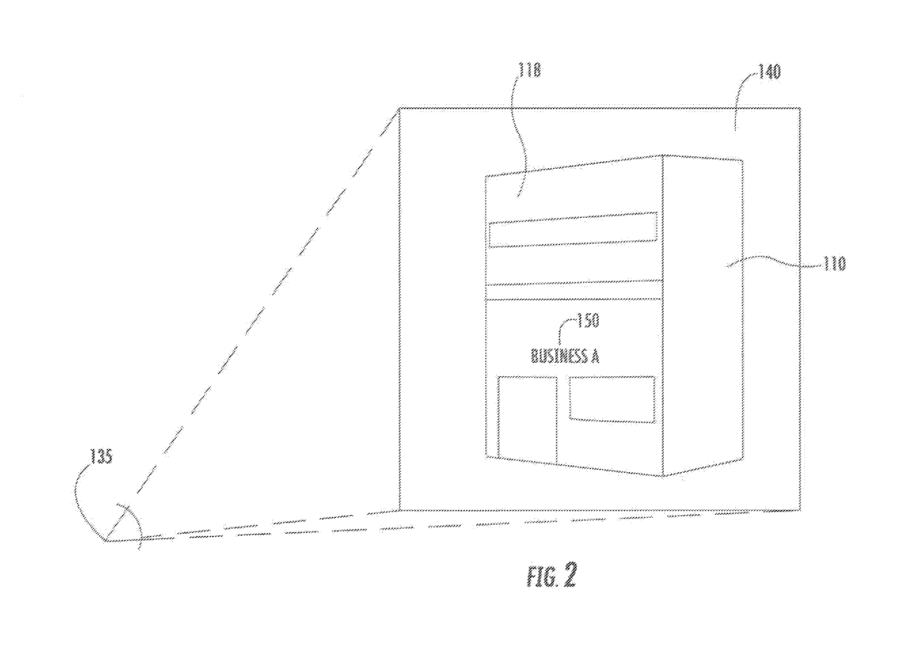

More specifically, the surveyor 120 can capture a source image of a storefront of a business 110 in the geographic area 100 using a suitable image capture device, such as a digital camera implemented on the user device 130. For example, FIG. 2 depicts an example source image 140 captured by a digital camera 135 implemented as part of the user device 130. The source image 140 is captured from a perspective at or near ground level and includes a storefront 118 of a business 110. The storefront 118 can include various identifying features associated with the business 110. For instance, the storefront 118 can include signage 150 identifying the business as “Business A.” In particular embodiments, multiple source images can be captured to improve accuracy of the matching process discussed in more detail below.

The source image 140 can be uploaded to the storefront recognition application implemented on the user device 130. Once the source image 140 is received, the application can compare the source image 140 against a plurality of candidate images of storefronts in the geographic area. In particular implementations, the plurality of candidate images are images of storefronts associated with entities that have previously been investigated. The plurality of candidate images of storefronts can be previously collected images, such as street level images, captured of the businesses 110 in the geographic area 100 (FIG. 1). Street level images can include images captured by a camera of the geographic area from a perspective at or near ground level. The plurality of candidate images can be accessed by the storefront recognition application from a remote device, such as a web server associated with the geographic information system, or can be accessed from local storage on the user device 130.

In one particular implementation, the surveyor 120 can download the plurality of candidate images from a remote device to the user device 130 prior to traveling to the geographic area 100. For instance, prior to traveling to the geographic area 100, the surveyor 120 can provide a request to a remote device or system having access to the candidate images including data indicative of one or more geographic areas to be surveyed. A plurality of candidate images can be identified based on the data indicative of the one or more geographic areas to be investigated. For instance, candidate images of storefronts that are geolocated within the geographic area can be identified. The number of candidate images can be limited, such as limited to 100 candidate images. The identified candidate images can be downloaded and stored locally on the user device 130. In this way, the storefront recognition application can be implemented by the user device 130 in the field without requiring network connectivity.

The storefront recognition application implemented on the computing device 130 can compare the source image, such as source image 140, with the plurality of candidate images using a computer-implemented feature matching process. The feature matching process can attempt to match one or more features (e.g. text) depicted in the source image 140 with features depicted in the candidate images. In a particular implementation, the storefront recognition application can compare images using a sift invariant feature transform (SIFT) feature matching process implemented using one or more geometric constraints. The use of a limited number of candidate images can facilitate implementation of the feature matching process locally at the user device 130. Other feature matching techniques (e.g. optical character recognition techniques for text) can be used without deviating from the scope of the present disclosure.

The storefront recognition application can generate a similarity score for each candidate image using the feature matching process. The similarity score for each candidate image can be indicative of the similarity of the one or more source images (e.g. source image 140) to the candidate image. In one particular implementation, the similarity score for a candidate image can be determined based at least in part on the number and/or type of matched features between the source image and the candidate image.

The storefront recognition application can identify a subset of the plurality of candidate images based at least in part on the similarity score for each of the plurality of candidate images. The subset can include one or more of the plurality of candidate images. In one particular implementation, the subset is identified by ranking the plurality of candidate images into a priority order based on the similarity score (e.g. ranking the candidate images from highest similarity score to lowest similarity score) and identifying one or more of the plurality of candidate images that are ranked highest in the priority order as the subset.

The storefront recognition application can present the one or more source images and the identified subset of the plurality of images in a user interface presented on a display device associated with user device 130. The surveyor 120 can compare the one or more source images with the returned candidate images in the subset to determine whether the business needs to be investigated. According to particular aspects of the present disclosure, the subset of the plurality of images can be presented in the user interface in the priority order determined by ranking the plurality of candidate images based on the similarity score for each candidate image. In addition, each candidate image can be presented in conjunction with the similarity score for the candidate image. The color of the similarity score in the user interface can be selected based at least in part on a similarity score threshold. For instance, the similarity score can be presented in a first color (e.g. green) when the similarity score exceeds a threshold similarity score. The similarity score can be presented in a second color (e.g. red) when the similarity score does not exceed the threshold similarity score.

The surveyor 120 can review and analyze the subset of candidate images and associated similarity scores presented in the user interface of the storefront recognition application to determine whether the business needs to be investigated. If it is determined that a particular business needs to be investigated, the surveyor 120 can provide a user interaction with the storefront recognition application indicative of the user selecting the business for investigation. Data indicative of the user selection of the business for investigation can be communicated to a remote device, such as a remote device (e.g. server) associated with a geographic information system

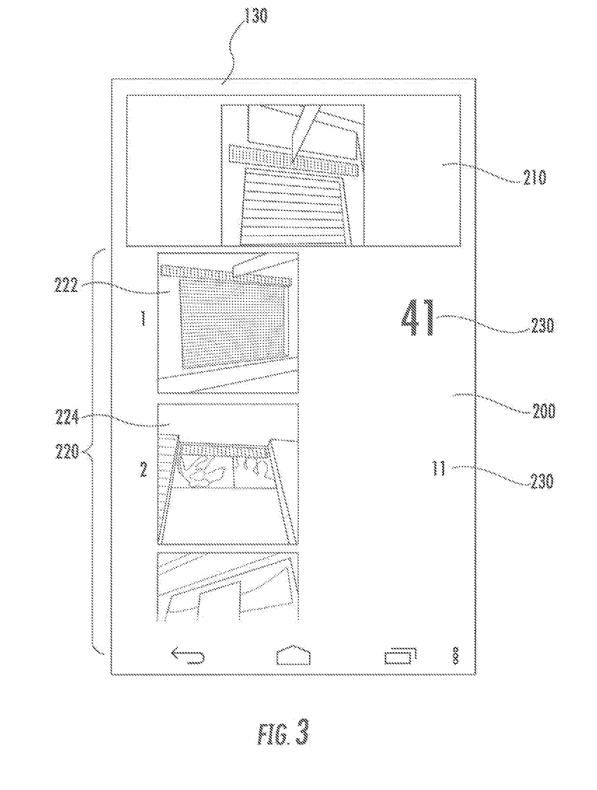

FIG. 3 depicts an example user interface 200 associated with a storefront recognition application according to example embodiments of the present disclosure. The user interface 200 can be presented on a display of user device 130. As shown, the user interface 200 presents the source image 210 captured of a storefront. The user interface 200 also presents a subset of candidate images 220. The subset of candidate images 220 are displayed according to a priority order determined by ranking the candidate images 220 (e.g. baaed on a similarity score). Additional candidate images 220 in the subset can be accessed by scrolling the user interface 200 using an appropriate user interaction, such as a touch gesture (e.g. a finger swipe).

As shown, a similarity score 230 is displayed in conjunction with each of the subset of candidate images 220 in the subset. For instance, a similarity score of 41 is displayed in conjunction with a first candidate image 222 and a similarly score of 11 is displayed in conjunction with a second candidate image 224. As shown, the similarity score of 41 displayed in conjunction with the first candidate image 22 can be displayed in a particular color (e.g. green) and size to indicate a close match. In one particular example implementation, the similarity score can be displayed in a particular color and size when the similarity score exceeds a similarity score threshold.

A surveyor can review the source image 210, the subset of candidate images 220, and/or the similarity scores 230 displayed in the user interface 200 to determine if there is a close match. If there is a close match as shown in FIG. 3, the surveyor can determine that the business associated with the storefront depicted in the source image 210 does not need to be investigated. The surveyor can provide an appropriate interaction or input to the user interface 200 to indicate that the business does not need to be investigated.

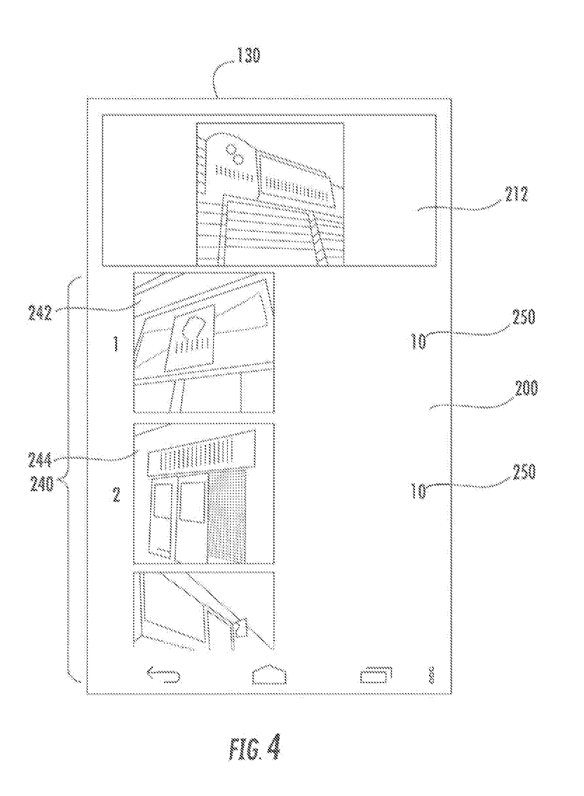

FIG. 4 depicts an example user interface 200 associated with a different source image 212. As shown, the user interface 200 presents the source image 210 and also presents a subset of candidate images 240. The subset of candidate images 240 are displayed according to a priority order determined by ranking the candidate images 240 (e.g. based on a similarity score). Additional candidate images 240 in the subset can be accessed by scrolling the user interface 200 using an appropriate user interaction, such as a touch gesture (e.g. a finger swipe).

As shown, a similarity score 250 is displayed in conjunction with each of the subset of candidate images 240 in the subset. For instance, a similarity score of 10 is displayed in conjunction with a first candidate image 242 and a similarity score of 10 is displayed in conjunction with a second candidate image 244. A surveyor can review the source image 212, the subset of candidate images 240, and/or the similarity scores 250 displayed in the user interface 200 to determine if there is a close match. If there is no close match as shown in FIG. 4, the surveyor can determine that the business associated with the storefront depleted in the source image 212 has changed and needs to be investigated. The surveyor can provide an appropriate interaction or input to the user interface 200 selecting the business or other entity to be investigated.

### Example Methods for Identifying Entities to be Investigated

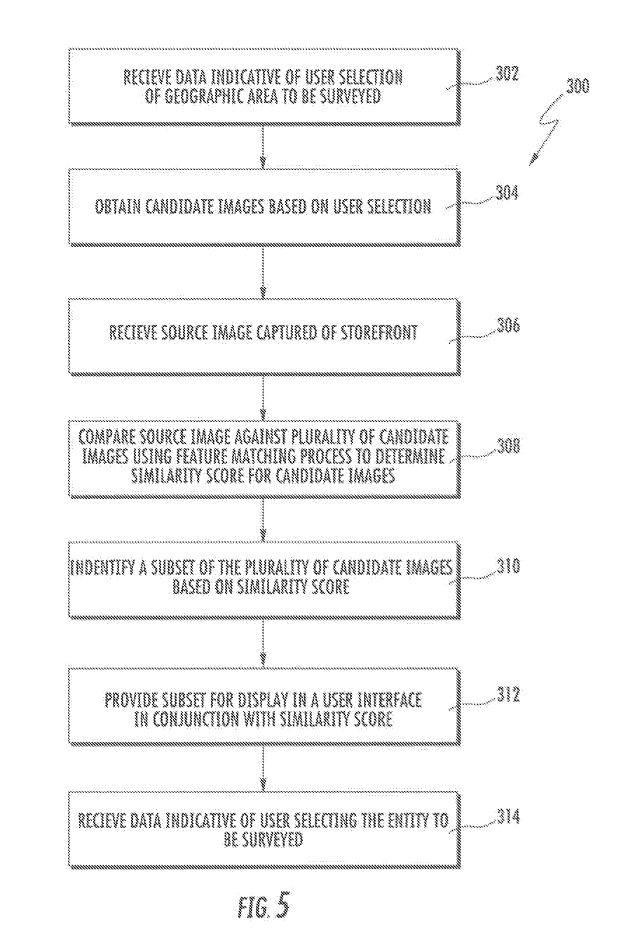

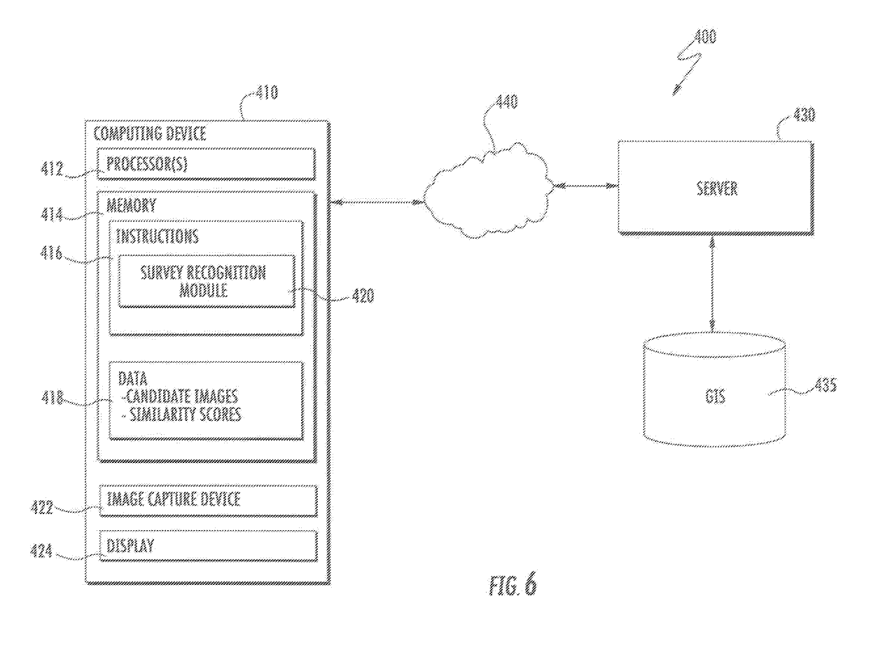

FIG. 5 depicts an example method (300) for identifying entities to be investigated in geographic areas according to an example aspect of the present disclosure. The method (300) can be implemented by one or more computing devices, such as one or more of the computing devices depleted in FIG. 6. In addition, FIG. 5 depicts steps performed in a particular order for purposes of illustration and discussion. Those of ordinary skill in the art, using the disclosures provided herein, will understand that the steps of any of the methods or processes disclosed herein can be modified, rearranged, omitted, or expanded in various ways without deviating from the scope of the present disclosure.

At (302), the method includes receiving data indicative of a geographic area to be investigated. For instance, a user can interact with a storefront recognition application implemented on a user device to select a particular geographic area (e.g. a street) to be investigated. Alternatively, a positioning system associated with user device can provide signals indicative of position/location of the user device. At (304), a plurality of candidate images can be obtained based on the user selection. For instance, the storefront recognition application can request and download a plurality of candidate images of storefronts in the geographic area from a remote device to, for instance, the user device.

At (306), one or more source images captured of a storefront can be received. For instance, a surveyor can capture a source image of a storefront in the geographic area using a digital camera implemented as part of the user device. Each of the one or more source images can be captured of the storefront from a perspective at or near ground level and facing the storefront. The one or more source images can be accessed by the storefront recognition application and processed to determine if the business or entity associated with the storefront needs to be investigated.

More particularly at (308), the one or more source images can be compared against the plurality of candidate images using a computer-implemented feature matching process to determine a similarity score for each of the candidate images. For example, a feature matching process can match features between the one or more source images and each candidate image based on, for instance, color and/or intensity. One example feature matching process includes a SIFT feature matching process. In this example embodiment, features can be extracted from the source image and each of the candidate images to provide a description for each of the source image and each candidate image. The extracted features can be compared to identify matches. In particular implementations, the feature matching process can implement a geometric constraint to reduce false matches. The geometric constraint can be an epipolar constraint or a perspective constraint.

The similarity score for a candidate image can be derived based on the feature matching process and can be indicative of the similarity of the source image to the candidate image. In a one example implementation, the similarity score is determined based at least in part on the number of matched features between the source image and the candidate image. Each matched feature can be weighted in the determination of the similarity score depending on the confidence of the match between features.

Once the similarity scores for the candidate images have been determined, a subset of the plurality of candidate images can be identified based on the similarity scores for each of the plurality of candidate images (310). For example, one or more candidate images with the highest similarity scores can be selected as the subset of candidate images. In a particular implementation, identifying the subset of candidate images can include ranking the plurality of candidate images into a priority order based at least in part on the similarity score for each candidate image and identifying one or more of the plurality of candidate images ranked highest in the priority order as the subset.

At (312), the identified subset is provided for display in a user interface. The identified subset can be displayed in conjunction with the source image for visual comparison by the surveyor. In addition, each candidate image in the subset can be annotated with the similarity score determined for the candidate image. The size and color of the similarity scores displayed in conjunction the candidate images can be selected based on the closeness of the match. For example, higher similarity scores can be presented in the color green with large text size for close matches while lower similarity scores can be presented in the color red with small text size to facilitate surveyor recognition of close matches.

At (314), the method can include receiving data indicative of a user selecting the entity to be investigated. For instance, if a surveyor determines based on review the source image, the subset of candidate images, and/or the similarity scores that the entity has not changed, the surveyor can provide data indicative of the surveyor selecting the entity as not needing to be investigated. If the surveyor determined based on review based on review the source image, the subset of candidate images, and/or the similarity scores that the entity has not changed, the surveyor can provide data indicative of the surveyor selecting the entity to be investigated

### Example Computing Systems for Identifying Entities to be Investigated

FIG. 6 depicts a computing system 400 that can be used to implement the methods and systems for identifying entities to be investigated according to example aspects of the present disclosure. The system 400 can be implemented using a client-server architecture that includes a computing device 410 that communicates with one or more servers 430 (e.g. web servers) over a network 440. The system 400 can be implemented using other suitable architectures, such as a single computing device.

The system can include a computing device 410. The computing device 410 can be any suitable type of computing device, such as a general purpose computer, special purpose computer, laptop, desktop, mobile device, smartphone, tablet, wearable computing device, a display with one or more processors, or other suitable computing device. The computing device 410 can include one or more processor(s) 412 and one or more memory devices 414.

The one or more processor(s) 412 can include any suitable processing device, such as a microprocessor, microcontroller, integrated circuit, logic device, one or more central processing units (CPUs), graphics processing units (GPUs) dedicated to efficiently rendering images or performing other specialized calculations, and/or other processing devices. The one or more memory devices 414 can include one or more computer-readable media, including, but not limited to, non-transitory computer-readable media, RAM, ROM, hard drives, flash drives, or other memory devices.

The one or more memory devices 414 store information accessible by the one or more processors 412, including instructions 416 that can be executed by the one or more processors 412. For instance, the memory devices 414 can store instructions 416 for implementing a storefront recognition module 420 configured to identify entities for investigation according to example aspects of the present disclosure. The one or more memory devices 414 can also include data 418 that can be retrieved, manipulated, created, or stored by the one or more processors 412. The data 418 can include, for instance, a plurality of candidate images, similarity scores, source images, etc.

It will be appreciated that the term “module” refers to computer logic utilized to provide desired functionality. Thus, a module can be implemented in hardware, application specific circuits, firmware and/or software controlling a general purpose processor. In one embodiment, the modules are program code files stored on the storage device, loaded into one or more memory devices and executed by one or more processors or can be provided from computer program products, for example computer executable instructions, that are stored in a tangible computer-readable storage medium such as RAM, hard disk or optical or magnetic media. When software is used, any suitable programming language or platform can be used to implement the module.

The computing device 410 can include various input/output devices for providing and receiving information from a user, such as a touch screen, touch pad, data entry keys, speakers, and/or a microphone suitable for voice recognition. For instance, the computing device 410 can have a display 424 for providing a user interface for a storefront recognition application according to example embodiments of the present disclosure.

The computing device 410 can further include an integrated image capture device 422, such as a digital camera. The image capture device 422 can be configured to capture source images of storefronts according to example embodiments of the present disclosure. The image capture device 422 can include video capability for capturing a sequence of images/video.

The computing device 410 can further include a positioning system. The positioning system can include one or more devices or circuitry for determining the position of a client device. For example, the positioning device can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, or low-power (e.g. BLE) beacons, and the like and/or other suitable techniques for determining position.

The computing devices can also include a network interface used to communicate with one or more remote computing devices (e.g. server 430) over the network 440. The network interface, can include any suitable components for interfacing with one more networks, including for example, transmitters, receivers, ports, controllers, antennas, or other suitable components.

The system 400 includes a server 430, such as a web server. The server 430 can host or be in communication with a geographic information system 435. The server 430 can be implemented using any suitable computing device(s). The serves 430 can have one or more processors and memory. The server 430 can also include a network interface used to communicate with computing device 410 over the network 440. The network interface can include any suitable components for interfacing with one more networks, including for example, transmitters, receivers, ports, controllers, antennas, or other suitable components.

The server 430 can exchange data with the computing device 410 over the network 440. The network 440 can be any type of communications network, such as a local area network (e.g. intranet), wide area network (e.g. Internet), cellular network, or some combination thereof. The network 440 can also include a direct connection between a computing device 410 and the server 430. In general, communication between the server 430 and a computing device 410 can be carried via network interface using any type of wired and/or wireless connection, using a variety of communication, protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of identifying entities to be investigated in geographic areas, comprising:
receiving, by one or more computing devices, a source image captured of a storefront of an entity in a geographic area, the source image being captured by an image capture device, wherein the one or more computing devices comprise one or more processors;
accessing, by the one or more computing devices, a plurality of candidate images of storefronts in the geographic area;
comparing, by the one or more computing devices, the source image against the plurality of candidate images to determine a similarity score for each of the plurality of candidate images;
identifying, by the one or more computing devices, a subset of the plurality of candidate images based at least in part on the similarity score for each of the plurality of candidate images;
providing, by the one or more computing devices, the subset of the plurality of candidate images for display in a user interface presented on a display device, each candidate image of the subset of the plurality of candidate images being provided for display in the user interface in conjunction with the similarity score for the candidate image; and
receiving, by the one or more computing devices, data indicative of a user selecting the entity to be investigated.

2. The computer-implemented method of claim 1, wherein the method further comprises providing, by the one or more computing devices, the source image for display in the user interface in conjunction with the subset of the plurality of candidate images and the similarity score for each candidate image.

3. The computer-implemented method of claim 1, wherein the method comprises:
receiving, by the one or more computing devices, data indicative of the geographic area to be investigated; and
obtaining, by the one or more computing devices, the plurality of candidate images based at least in part on the user selection of the geographic area to be investigated.

4. The computer-implemented method of claim 1, wherein the source image is compared against the plurality of candidate images using a feature matching process.

5. The computer-implemented method of claim 1, wherein the similarity score for each candidate image is determined based at least in part on a number of matched features between the source image and the candidate image identified using the feature matching process.

6. The computer-implemented method of claim 5, wherein the feature matching process comprises a scale invariant feature transform (SIFT) feature matching process.

7. The computer-implemented method of claim 5, wherein the feature matching process is implemented using a geometric constraint.

8. The computer-implemented method of claim 7, wherein the geometric constraint comprises an epipolar constraint or a perspective constraint.

9. The computer-implemented method of claim 1, wherein identifying, by the one or more computing devices, a subset of the plurality of candidate images based at least in part on the similarity score for each of the plurality of candidate images comprises:
ranking, by the one or more computing devices, the plurality of candidate images into a priority order bused at least in part on the similarity score for each candidate image; and
identifying, by the one or more computing devices, one or more of the plurality of candidate images ranked highest in the priority order as the subset.

10. The computer-implemented method of claim 1, wherein the method comprises selecting, by the one or more computing devices, a color of the similarity score for display in the user interface for each candidate image in the subset of the plurality of candidate images based at least in part on a similarity score threshold.

11. The computer-implemented method of claim 1, wherein the geographic area is a street.

12. The computer-implemented method of claim 11, wherein the entity is a business located on the street.

13. A computing system, comprising:
an image capture device;
a display device;
one or more processors;
one or more memory devices, the one or more memory devices storing computer-readable instructions that when executed by the one or more processors cause the one or more processors to perform operations, the operations comprising:
receiving a source image captured by the image capture device of a storefront of an entity in a geographic area;
accessing, from the one or more memory devices, a plurality of candidate images of storefronts in the geographic area;
comparing the source image against the plurality of candidate images to determine a similarity score for each of the plurality of candidate images;
identifying a subset of the plurality of candidate images based at least in part on the similarity score for each of the plurality of candidate images;
providing the subset of the plurality of candidate images for display in a user interface presented on the display device, each candidate image of the subset of the plurality of candidate images being provided for display in the user interface in conjunction with the similarity score for the candidate image; and
receiving data indicative of a user selecting the entity to be investigated.

14. The computing system of claim 13, wherein the operations further comprise providing the source image for display in the user interface in conjunction with the subset of the plurality of candidate images and the similarity score for each candidate image.

15. The computing system of claim 13, wherein the operations further comprise:
receiving data indicative of the geographic area to be investigated; and
obtaining, via a network interface, the plurality of candidate images based at least in part on the user selection of the geographic area to be surveyed.

16. The computing system of claim 13, wherein the source image is compared against the plurality of candidate images using a feature matching process, the similarity score for each candidate image being determined based at least in part on a number of matched features between the source image and the candidate image identified using the feature matching process.

17. The computing system of claim 13, wherein the operations comprise selecting a color of the similarity score for display in the user interface for each candidate image in the subset of the plurality of candidate images based at least in part on a similarity score threshold.

18. One or more tangible, non-transitory computer-readable media storing computer-readable instructions that when executed by one or more processors, cause the one or more processors to perform operations, the operations comprising:
receiving a source image captured by the image capture device of a storefront of an entity in a geographic area;
accessing a plurality of candidate images of storefronts in tire geographic area;
comparing the source image against the plurality of candidate images to determine a similarity score for each of the plurality of candidate images;
identifying a subset of the plurality of candidate images based at least in part on the similarity score for each of the plurality of candidate images;
providing the subset of the plurality of candidates images for display in a user interface presented on the display device,
providing the similarity score for each candidate image in the subset for display in the user interface in conjunction with the subset of the plurality of candidate images; and
receiving data indicative of a user selecting the entity to be investigated.

19. The tangible, non-transitory computer-readable media of claim 18, wherein the operations further comprise providing the source image for display in the user interface in conjunction with the subset of the plurality of candidate images and the similarity score for each candidate image.

20. The tangible, non-transitory computer-readable media of claim 18, wherein the source image is compared against the plurality of candidate images using a feature matching process, the feature matching process comprising a scale invariant feature transform (SIFT) feature matching process implemented using a geometric constraint, the similarity score for each candidate image being determined based at least in part on a number of matched features between the source image and the candidate image identified using the feature matching process.
